(19) United States
(12) Patent Application Publication
(10) Pub. No.: US 2018/0293917 A1
(43) Pub. Date: Oct. 11, 2018

(54) BEVERAGE CONTAINER LABEL

(71) Applicant: Ashlee Rivers, Argyle, TX (US)

(72) Inventor: Ashlee Rivers, Argyle, TX (US)

(21) Appl. No.: 16/004,923

(22) Filed: Jun. 11, 2018

Related U.S. Application Data
(63) Continuation of application No. 29/637,450, filed on Feb. 19, 2018.
Application No. 29/637,450 is a continuation of application No. 29/637,449, filed on Feb. 19, 2018, now Pat. No. D820052.
Application No. 29/637,450 is a continuation of application No. 29/619,475, filed on Sep. 29, 2017, now Pat. No. D812990.
Application No. 29/637,449 is a continuation of application No. 29/619,475, filed on Sep. 29, 2017, now Pat. No. D812990.
Application No. 29/637,450 is a continuation of application No. 29/619,480, filed on Sep. 29, 2017, now Pat. No. D812991.
Application No. 29/637,449 is a continuation of application No. 29/619,480, filed on Sep. 29, 2017, now Pat. No. D812991.
Application No. 29/619,475 is a continuation of application No. 29/588,302, filed on Dec. 20, 2016, now Pat. No. D802376.
Application No. 29/619,480 is a continuation of application No. 29/588,302, filed on Dec. 20, 2016, now Pat. No. D802376.

(51) Int. Cl. G09F 3/02

(52) U.S. Cl. CPC G09F 3/02; G09F 2003/0272; B65D 2203/02; G09F 2003/0264; G09F 2003/0208

(57) ABSTRACT

A beverage container label that includes a unitary circular band; wherein, as viewed from a top plan view of the beverage container label: the unitary circular band defines a circumference; a first portion of the circumference is associated with a front portion of the unitary circular band; and a second portion of the circumference that is different from the first portion is associated with a rear portion of the band; and wherein, as viewed from a front view of the beverage container label, the front portion has upper and lower opposing parallel edges defining a first dimension of the front portion.

### CROSS-REFERENCE TO RELATED APPLICATIONS

This application is a continuation of U.S. application Ser. No. 29/637,450, filed Feb. 19, 2018, the entire disclosure of which is hereby incorporated herein by reference.

This application is a continuation of U.S. application Ser. No. 29/637,449, filed Feb. 19, 2018, the entire disclosure of which is hereby incorporated herein by reference.

Each of U.S. application Ser. No. 29/637,450 and U.S. application Ser. No. 29/637,449 is a continuation of U.S. application Ser. No. 29/619,475, filed Sep. 29, 2017, now U.S. Pat. No. D812,990.

Each of U.S. application Ser. No. 29/637,450 and U.S. application Ser. No. 29/637,449 is a continuation of U.S. application Ser. No. 29/619,480, filed Sep. 29, 2017, now U.S. Pat. No. D812,991, the entire disclosure of which is hereby incorporated herein by reference.

Each of U.S. application Ser. No. 29/619,475 and U.S. application Ser. No. 29/619,480 is a continuation of U.S. application Ser. No. 29/588,302, filed Dec. 20, 2016, now U.S. Pat. No. D802,376.

### BACKGROUND

This disclosure relates to a beverage container label.

### BRIEF DESCRIPTION OF THE DRAWINGS

FIG. 1 is a front perspective view of a beverage container label;

FIG. 2 is a front view of the beverage container label;

FIG. 3 is a rear view of the beverage container label;

FIG. 4 is a right side view of the beverage container label;

FIG. 5 is a left side view of the beverage container label;

FIG. 6 is a top plan view of the beverage container label;

FIG. 7 is a bottom plan view of the beverage container label; and

FIG. 8 is a rear perspective view of the beverage container label.

### DETAILED DESCRIPTION

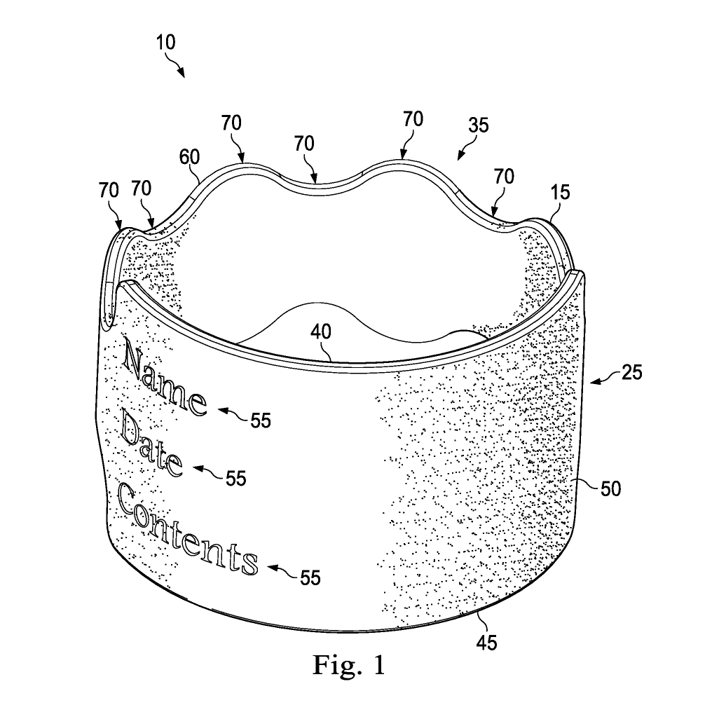

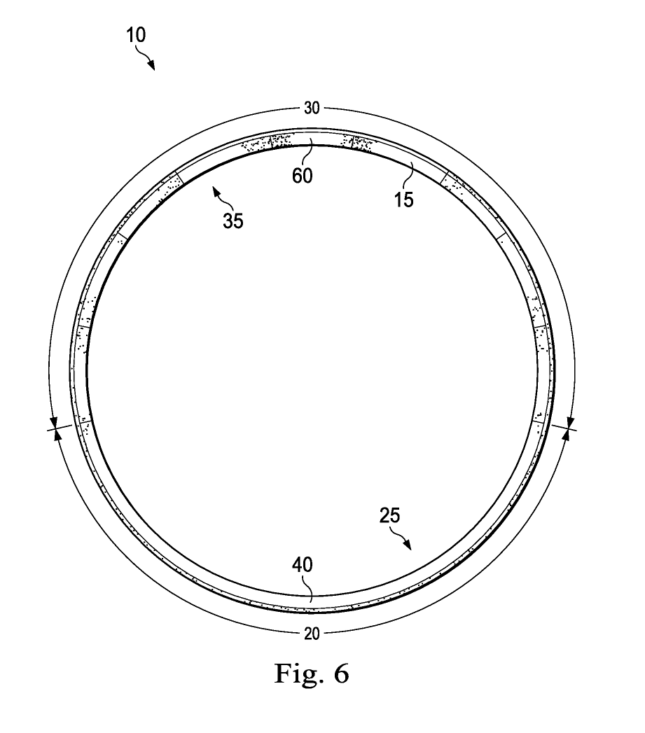

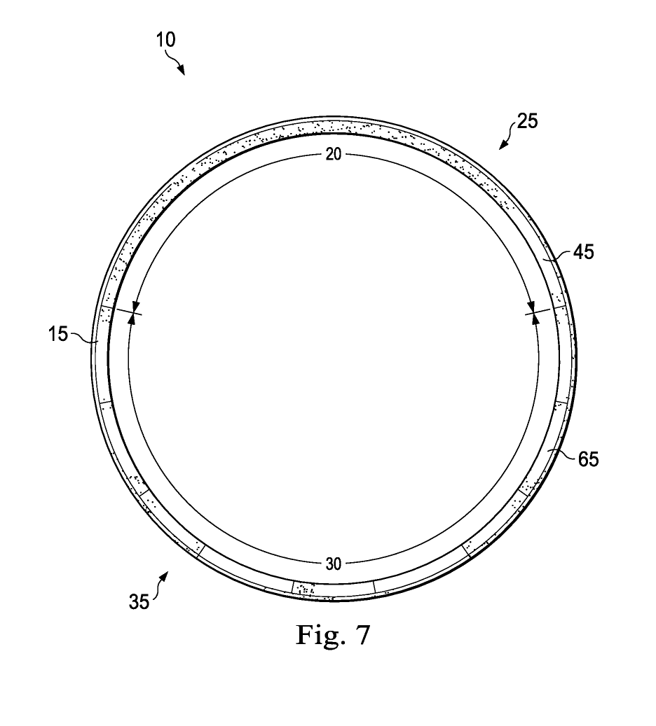

As illustrated in FIGS. 1-8, a beverage container label is referred to by the reference numeral 10. The beverage container label 10 includes a unitary circular band 15. When viewed from a top plan view (FIG. 6) and/or from a bottom plan view (FIG. 7) of the beverage container label 10, the unitary circular band 15 defines: a circumference, a first portion 20 of the circumference that is associated with a front portion 25 of the unitary circular band 15; and a second portion 30 of the circumference, which is different from the first portion 20, that is associated with a rear portion 35 of the band 15.

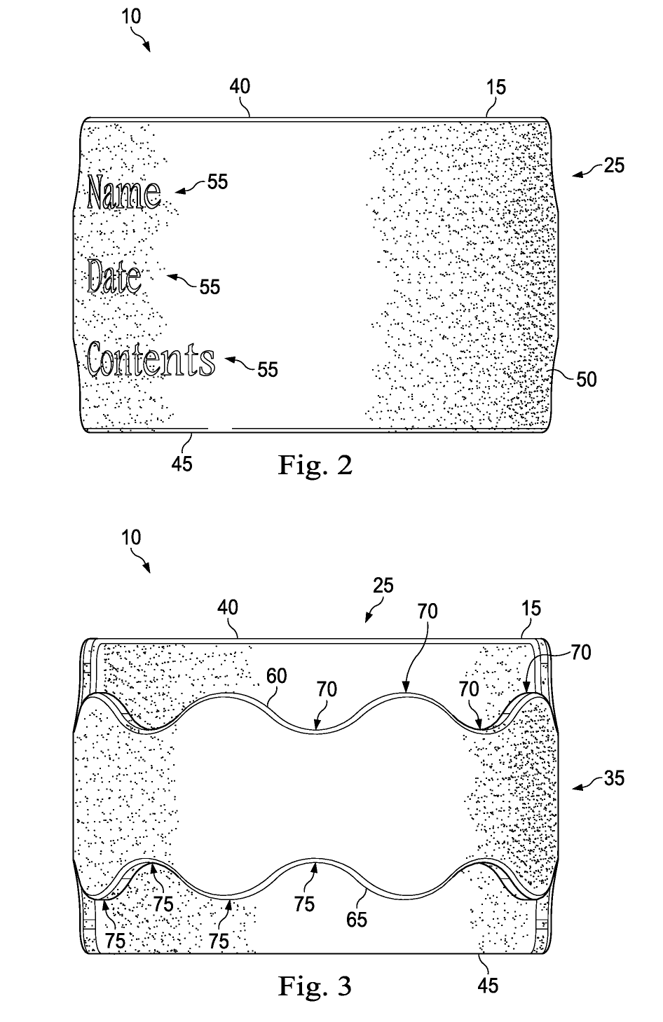

When viewed from a front view (FIG. 2) of the beverage container label 10, the front portion 25 has an upper parallel edge 40 that extends parallel to an opposing lower parallel edge 45. The upper and lower parallel edges 40, 45 define a first dimension of the front portion 25. When viewed from the front view (FIG. 2), the first dimension of the front portion 25 is a height of the front portion 25. As viewed from the front view (FIG. 2) of the beverage container label 10, the front portion 25 of the band 15 has a rectangular shape.

When viewed from the front view (FIG. 2), the front perspective view (FIG. 1), and the left side view (FIG. 5), a front surface 50 of the front portion 25 displays category indicia 55 representing identification categories, the category indicia 55 including a name category indicium, a date category indicium, and a contents category indicium. The front surface 50 of the front portion 25 is sized to receive an identification indicium associated with each of the category indicia 55.

As viewed from a rear view (FIG. 3) of the beverage container label 10, an upper edge 60 of the rear portion 35 is spaced from the upper parallel edge 40 of the front portion 25 and a lower edge 65 of the rear portion 35 is spaced from the lower parallel edge 45 of the front portion 25.

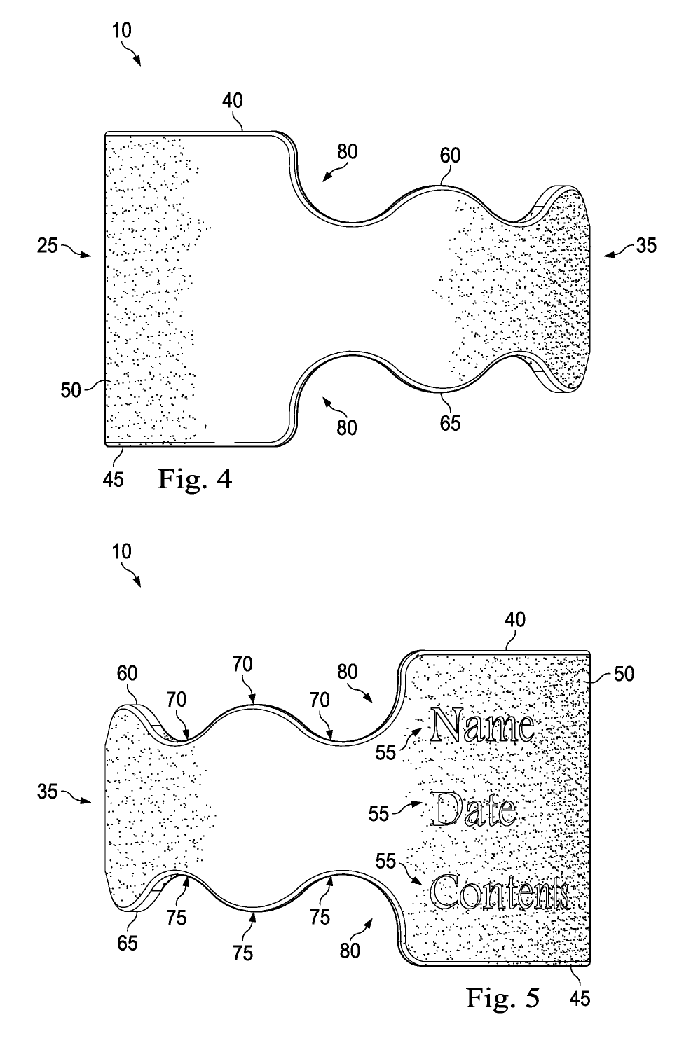

As viewed from the rear view (FIG. 3), the right side view (FIG. 4), and the left side view (FIG. 5) of the beverage container label 10: a portion of the upper edge 60 of the rear portion 35 is a convex curved upper edge, and a corresponding portion of the lower edge 65 of the rear portion 35 is a convex curved lower edge. As viewed from the rear view (FIG. 3), the right side view (FIG. 4), and the left side view (FIG. 5) of the beverage container label 10: the upper edge 60 of the rear portion 35 forms a plurality of rounded portions 70, and the lower edge 65 of the rear portion 35 forms a plurality of rounded portions 75. As viewed from the rear view (FIG. 3) of the beverage container label 10, each of the upper and lower edges 60, 65 of the rear portion 35 is positioned between the upper and lower parallel edges 40, 45 of the front portion 25.

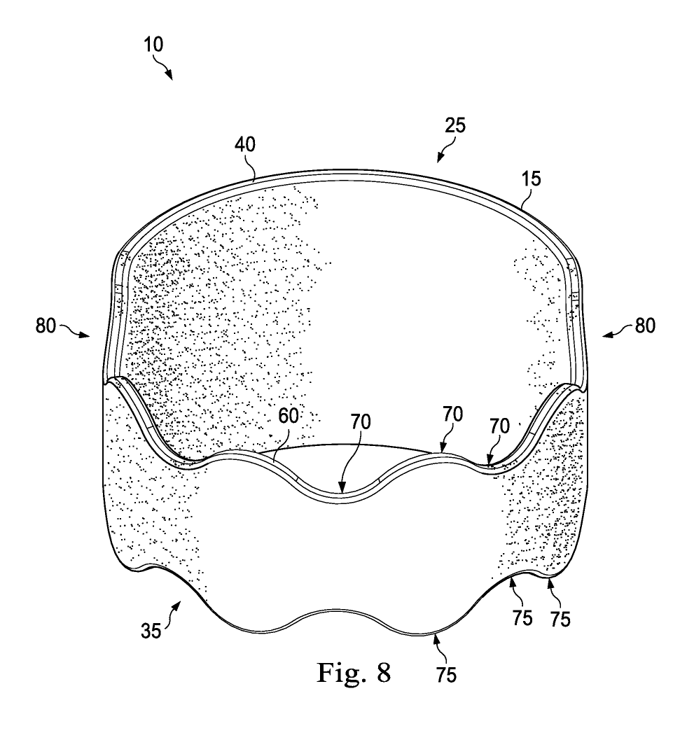

As viewed from the rear view (FIG. 3), the right side view (FIG. 4), and the left side view (FIG. 5) of the beverage container label 10: the upper and lower opposing edges 60, 65 define a dimension of the rear portion 35 in a first direction; and the upper and lower opposing edges 40, 45 define a dimension of the front portion 25 in the first direction. The dimension of the rear portion 35 is less than the dimension of the front portion 25. As viewed from the right side view (FIG. 4), the left side view (FIG. 5), and the rear perspective view (FIG. 8) of the beverage container label 10, the upper edge 60 of the rear portion 35 curves to intersect the front portion 25 at a transition portion 80.

As viewed from the right side view (FIG. 4), the left side view (FIG. 5), and the rear view (FIG. 3) of the beverage container label 10: the upper edge 60 of the rear portion 35 is a mirror image of the lower edge of the rear portion 35; and the upper edge 40 of the front portion 25 is a mirror image of the lower edge 45 of the front portion 25.

What is claimed is:

1. A beverage container label, comprising a unitary circular band;
wherein, as viewed from a top plan view of the beverage container label:
the unitary circular band defines a circumference;
a first portion of the circumference is associated with a front portion of the unitary circular band; and
a second portion of the circumference that is different from the first portion is associated with a rear portion of the band; and
wherein, as viewed from a front view of the beverage container label, the front portion has upper and lower opposing parallel edges defining a first dimension of the front portion.

2. The beverage container label of claim 1, wherein the first dimension of the front portion is a height of the front portion.

3. The beverage container label of claim 1,
wherein a front surface of the front portion displays a first category indicium; and
wherein the front surface of the front portion is sized to receive a first identification indicium associated with the first category indicium.

4. The beverage container label of claim 3, wherein the first category indicium is a name category indicium;
wherein the front surface of the front portion displays a second category indicium; and
wherein the front surface of the front portion is sized to receive a second identification indicium associated with the second category indicium.

5. The beverage container label of claim 1, wherein, as viewed from a rear view of the beverage container label, an upper edge of the rear portion is spaced from the upper parallel edge of the front portion and a lower edge of the rear portion is spaced from the lower parallel edge of the front portion.

6. The beverage container label of claim 5, wherein, as viewed from the rear view of the beverage container label, a portion of the upper edge of the rear portion is a convex curved upper edge, and a corresponding portion of the lower edge of the rear portion is a convex curved lower edge.

7. The beverage container label of claim 5, wherein, as viewed from the rear view of the beverage container label, the upper edge of the rear portion forms a first plurality of rounded portions, and the lower edge of the rear portion forms a second plurality of rounded portions.

8. The beverage container label of claim 1, wherein, as viewed from the front view of the beverage container label, the front portion has a rectangular shape.

9. A beverage container label, comprising a unitary circular band;
wherein, as viewed from a top plan view of the beverage container label:
the circular band defines a circumference;
a first portion of the circumference is associated with a front portion of the band; and
a second portion of the circumference that is different from the first portion is associated with a rear portion of the band; and
wherein, as viewed from a side view of the beverage container label:
the rear portion has upper and lower opposing edges defining a dimension of the rear portion in a first direction; and
the front portion has upper and lower opposing edges defining a dimension of the front portion in the first direction; and
wherein the dimension of the rear portion is less than the dimension of the front portion.

10. The beverage container label of claim 9, wherein as viewed from the side view of the beverage container label, the upper edge of the rear portion curves to intersect the front portion.

11. The beverage container label of claim 9, wherein, as viewed from the rear view of the beverage container label, the upper edge of the rear portion forms a first plurality of rounded portions, and the lower edge of the rear portion forms a second plurality of rounded portions.

12. The beverage container label of claim 9, wherein as viewed from the side view of the beverage container label, the upper edge of the rear portion is a mirror image of the lower edge of the rear portion.

13. The beverage container label of claim 9, wherein, as viewed from a rear view of the beverage container label, a portion of the upper edge of the rear portion is a convex curved upper edge, and a corresponding portion of the lower edge of the rear portion is a convex curved lower edge.

14. A beverage container label, comprising a unitary circular band;
wherein, as viewed from a top plan view of the beverage container label:
the circular band defines a circumference;
a first portion of the circumference is associated with a front portion of the band; and
a second portion of the circumference that is different from the first portion is associated with a rear portion of the band; and
wherein, as viewed from a side view of the beverage container label:
the rear portion has upper and lower opposing edges defining a dimension of the rear portion in a first direction; and
the front portion has upper and lower opposing parallel edges defining a dimension of the front portion in the first direction; and
wherein the dimension of the rear portion is less than the dimension of the front portion.

15. The beverage container label of claim 14,
wherein a front surface of the front portion displays a first category indicium; and
wherein the front surface of the front portion is sized to receive a first identification indicium associated with the first category indicium.

16. The beverage container label of claim 15, wherein the first category indicium is a name category indicium;
wherein the front surface of the front portion displays a second category indicium; and
wherein the front surface of the front portion is sized to receive a second identification indicium associated with the second category indicium.

17. The beverage container label of claim 14, wherein, as viewed from a rear view of the beverage container label, each of the upper and lower edges of the rear portion is positioned between the upper and lower parallel edges of the front portion.

18. The beverage container label of claim 14, wherein, as viewed from a rear view of the beverage container label, a portion of the upper edge of the rear portion is a convex curved upper edge, and a corresponding portion of the lower edge of the rear portion is a convex curved lower edge.

19. The beverage container label of claim 14, wherein as viewed from the side view of the beverage container label, the upper edge of the rear portion curves to intersect the front portion.

20. The beverage container label of claim 14, wherein as viewed from the side view of the beverage container label, the upper edge of the rear portion is a mirror image of the lower edge of the rear portion.
